(19) United States
(12) Patent Application Publication
(10) Pub. No.: US 2009/0003368 A1
(43) Pub. Date: Jan. 1, 2009

(54) SYSTEM AND METHOD FOR GRAPHICALLY REPRESENTING AND MANAGING COMPUTER NETWORK CONNECTIONS

(75) Inventor: Jeremy Ray Brown, Orem, UT (US)

Correspondence Address: HAYNES AND BOONE, LLP;IP Section, 2323 Victory Avenue, Suite 700, Dallas, TX, 75219, US

(73) Assignee: NOVELL, INC., Provo, UT (US)

(21) Appl. No.: 11/768,997

(22) Filed: Jun. 27, 2007

(51) Int. Cl. H04L 12/28

(52) U.S. Cl. 370/410

(57) ABSTRACT

System and method for graphically representing and managing computer network connections are described. One embodiment is a method for providing an overlay filter in a computer capable of at least one secure network connection for use by at least one user application of the computer. The method comprises establishing a first secure network connection; launching a first application via the first secure network connection; and presenting on a display of the computer a visual representation, the visual representation illustrating that the first application is using the first secure network connection and comprising a first overlay area corresponding to the first secure network connection, wherein a first icon representing the first application is displayed within the first overlay area.

### BACKGROUND

A virtual private network (“VPN”) is a private communications network that is typically used by organizations or businesses to communicate confidentially over a public network. VPN traffic can be carried over the Internet or other public network atop standard protocols. VPN traffic can also be carried over a private network maintained by a service provider under the terms of a service level agreement (“SLA”). Using a VPN, data may be transmitted across secured and encrypted private channels between two points.

Similarly, tunneling is a method of transmitting data through a public network in such a way that the routing nodes of the public network are unaware that the transmission is part of a private network. Tunneling is typically accomplished by encapsulating the private network data and protocol information within the public network protocol data so that the tunneled data is not available to anyone examining the transmitted data frames. Tunneling enables public networks to be used to carry data on behalf of users as though they had access to a private network.

The complexity of computer applications and the ability to establish tunnels and/or VPN connections through a portion of such applications may be challenging to a typical user. For example, the user may be unaware that a particular application would benefit from a secure network connection. Additionally, efficiently managing multiple secure network connections, each affording a different level and type of security, could prove challenging to the average user.

### SUMMARY

One embodiment is a method for providing an overlay filter in a computer capable of at least one secure network connection for use by at least one user application of the computer. The method comprises establishing a first secure network connection; launching a first application via the first secure network connection; and presenting on a display of the computer a visual representation, the visual representation illustrating that the first application is using the first secure network connection and comprising a first overlay area corresponding to the first secure network connection, wherein a first icon representing the first application is displayed within the first overlay area.

Another embodiment is a computer program product for providing an overlay filter in a computer capable of at least one secure network connection for use by at least one user application of the computer. The computer program product comprises computer-readable medium having stored thereon computer-executable instructions for establishing a first secure network connection; launching a first application via the first secure network connection; and presenting on a display of the computer a visual representation, the visual representation illustrating that the first application is using the first secure network connection and comprising a first overlay area corresponding to the first secure network connection, wherein a first icon representing the first application is displayed within the first overlay area.

Yet another embodiment is a system for providing an overlay filter in a computer capable of at least one secure network connection for use by at least one user application of the computer. The system comprises means for launching a first application via a first secure network connection and means for presenting on a display of the computer a visual representation. The visual representation illustrates that a first application is using the first secure network connection and comprises a first overlay area corresponding to the first secure network connection, wherein a first icon representing the first application is displayed within the first overlay area.

### BRIEF DESCRIPTION OF THE DRAWINGS

FIG. 1 is a block diagram of a computer in which one embodiment of an overlay filter may be implemented.

FIG. 2 illustrates one embodiment of a visual display of the overlay filter of FIG. 1.

FIG. 3 is a flowchart of the operation of an embodiment of the overlay filter of FIG. 1.

### DETAILED DESCRIPTION

To better illustrate the advantages and features of the invention, a particular description of several embodiments will be provided with reference to the attached drawings. These drawings, and other embodiments described herein, only illustrate selected aspects of the invention and do not limit the invention's scope. Further, despite reference to specific features illustrated in the example embodiments, it will nevertheless be understood that these features are not essential to all embodiments and no limitation of the scope of the invention is thereby intended. Any alterations and further modifications in the described embodiments, and any further applications of the principles of the invention as described herein are contemplated as would normally occur to one skilled in the art. Furthermore, some items are shown in a simplified form, and inherently include components that are well known in the art. Further still, some items are illustrated as being in direct connection for the sake of simplicity and clarity. Despite the apparent direct connection, it is understood that such illustration does not preclude the existence of intermediate components not otherwise illustrated.

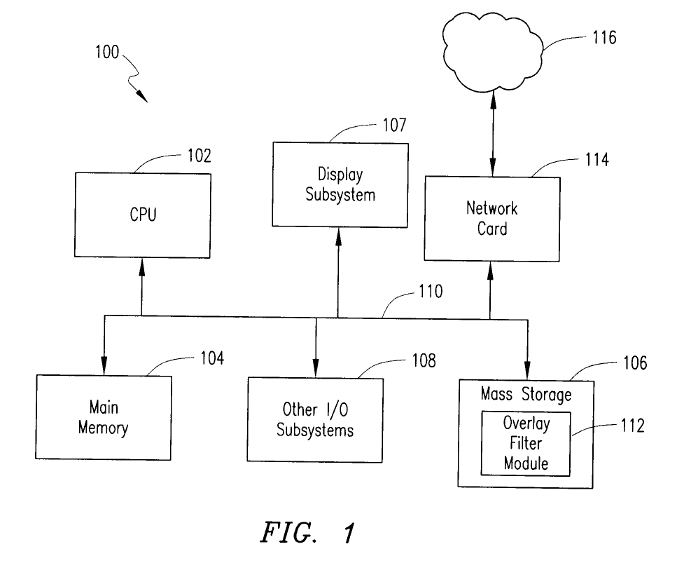

FIG. 1 is a block diagram of a conventional computer system 100 in which an overlay filter in accordance with one embodiment may be implemented. As shown in FIG. 1, the computer system 100 includes a central processing unit (“CPU”) 102, main memory 104, mass storage 106, a display subsystem 107, and other I/O subsystems, collectively designated by reference numeral 108, all interconnected via one or more buses, collectively represented in FIG. 1 by a bus 110. In one embodiment, as will be described in greater detail herein, an overlay filter module 112 comprising computer program instructions for implementing the overlay filter of one embodiment is installed on the computer 100. The computer 100 further includes one or more network cards, such as a network card 114, for enabling the computer 100 to communicate with other computers or servers (not shown) via one or more networks, such as the Internet 116.

As will be described in greater detail below, in one embodiment, the overlay filter provides a simple way for a user to organize and visually distinguish applications for which a secure network connection is desirable or necessary, to launch applications using a secure or non-secure network connection, to layer secure network connections, and to quickly determine what type of connection is being used by each application running on the user's computer.

As computer networks and connections continue to evolve, so to do the security issues associated with such networks and connections. Additionally, security solutions are beginning to be used in combination to ensure that a connection is secure. For example, an application may use an Secure Sockets Layer (“SSL”) VPN to connect to a network and then use a tunnel to a secure box. Clearly, this is a complex issue and one that is not easily understood by the average computer user.

The filter overlay enables application security to be organized based on the requirements of the application itself. For example, browsers could be implemented with no security, e-mail applications would require a simple SSL VPN connection and code repositories would first require a full VPN connection and then a tunnel to the server where it is stored. A simple filter puts the application and types into the respective connection types and helps make the user's computer ultra-secure.

An enterprise environment could use the overlay filter to enforce security protocols for all applications on the desktops selectively. As a result, employees are not required to run through a VPN connection for all of their network connections, but the applications that carry sensitive data would automatically run through secure network connections. Additionally, there may be multiple types of connections that would work even in restricted networks with firewalls and closed ports.

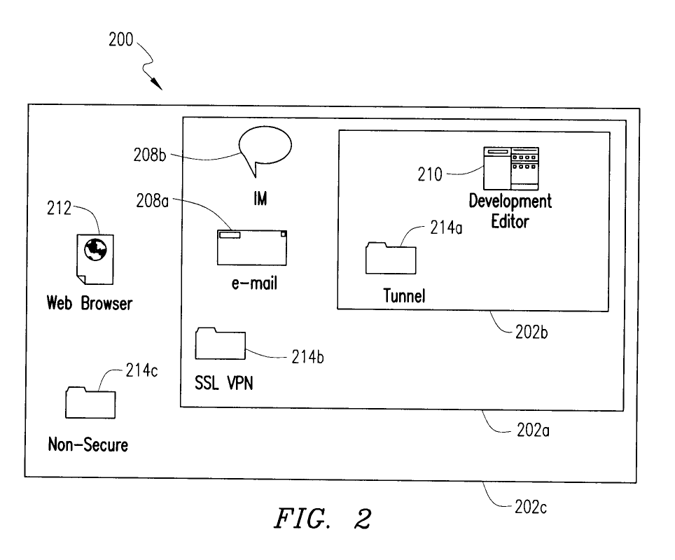

FIG. 2 illustrates a visual representation 200 of the overlay filter such as would be displayed on the display subsystem 107 of the computer 100 (FIG. 1). As shown in FIG. 2, the visual representation 200 includes multiple overlays 202a-202c, each of which defines a display area of the representation 200 and corresponds to a type of network connection. In the illustrated embodiment, the overlay 202a corresponds to an SSL VPN, the overlay 202b corresponds to a Tunnel, and the overlay 202c corresponds to a non-secure network connection. The fact that overlay 202b lies completely within the overlay 202a indicates that the Tunnel connection is layered on the SSL VPN connection. In one embodiment, each of the overlays 202a-202c is tinted a different color so as to further visually distinguish among them.

Application icons displayed within an area defined by an overlay represent an application that is implemented using the secure network connection to which the overlay corresponds. For example, application icons 208a and 208b displayed within the overlay 202a visually indicate to a user that the applications represented by the icons 208a, 208b (such as an email application and an IM application) effect network communications using the SSL VPN. Similarly, the application icon 210 displayed within the overlay 202b visually indicates to the user that the application represented by the icon 210 (such as a development editor and source code repository) utilize the SSL VPN and Tunnel network connections. The application icon 212 displayed within the overlay 202c visually indicates to the user that the application represented by the icon 212 (such as a web browser) utilizes a non-secure network connection.

Each of the overlays and area also has associated therewith a file icon 214a-214c, respectively, for enabling a user to launch applications using the corresponding connection. Preferably, clicking on one of the icons 214a-214c displays a list of applications for which the corresponding network connection is required or recommended. From that list, the user may launch one or more of the listed applications. Additionally, icons may be dragged from the desktop into the appropriate overlay 202a-202c to launch the corresponding application using the corresponding network connection.

In one aspect, after an application has been launched, the entire window and/or tool bar of the application may be tinted (preferably the same color of the overlay in which the applications icon is displayed) to indicate the type of secure network connection in use by the application. In another aspect, the icons and program menus may provide a visual indication (such as a color box displayed in association with the icon displayed on the desktop or tinting of the font of the program menu item for the application) of the type of network connection to be used for the corresponding application. It will be noted that this visual indication may represent a suggested configuration (i.e., the indicated connection is prefererable for the application) or a mandatory configuration (i.e., the indicated connection must be used for the application).

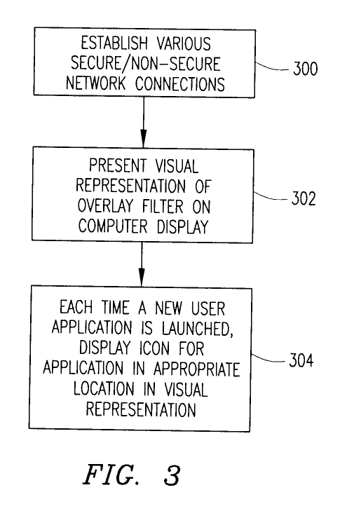

FIG. 3 is a flowchart of the operation of the overflow filter in accordance with one embodiment. In step 300, responsive to launch of the overflow filter, the various secure and non-secure network connections are established. Alternatively, these connections may already have been established by alternative means, in which case step 300 may involve merely determining what connections have been established or may be eliminated altogether. In step 302, which may occur substantially simultaneously with or subsequent to step 300, a visual representation (such as that shown in FIG. 2) of the overlay filter is presented on the display. The configuration of the visual representation presented in step 302 will reflect the available network connections, represented by overlays, as illustrated in FIG. 2. At this point, or at some time subsequent to this point, the user may layer connections (as illustrated in FIG. 2, in which the Tunnel connection is overlaid on the SSL VSN connection) using the visual representation.

Once the visual representation has been displayed in step 302, the user may launch applications using the secure network connections in any of a variety of manners, such as by dragging and dropping the application into the overlay area corresponding to the desired connection. In step 304, each time an application is launched, the icon therefore is displayed in the corresponding area of the visual representation. In this manner, the user is able to determine at-a-glance what network connections are being used for what applications.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. Moreover, the various steps may be initiated manually by a user or other actor or automatically in response to other steps or conditions. In addition, various functions illustrated in the methods or described elsewhere in the disclosure may be combined to provide additional and/or alternate functions. Therefore, the claims should be interpreted in a broad manner, consistent with the present disclosure.

What is claimed is:

1. A method for providing an overlay filter in a computer capable of at least one secure network connection for use by at least one user application of the computer, the method comprising:
establishing a first secure network connection;
launching a first application via the first secure network connection;
presenting on a display of the computer a visual representation, the visual representation illustrating that the first application is using the first secure network connection and comprising a first overlay area corresponding to the first secure network connection, wherein a first icon representing the first application is displayed within the first overlay area.

2. The method of claim 1 further comprising:
establishing a second secure network connection;
launching a second application via the second secure network connection;
wherein the visual representation further comprises a second overlay area corresponding to the second secure network connection, wherein a second icon representing the second application is displayed within the second overlay area.

3. The method of claim 2 further comprising:
layering the first and second secure network connections, wherein the second overlay area overlays the first overlay area in the visual representation.

4. The method of claim 1 wherein the launching a first application comprises dragging the first icon from a desktop of the computer display to the first overlay area.

5. The method of claim 1 further comprising:
establishing an unsecure network connection;
launching a second application via the unsecure network connection;
wherein the visual representation further comprises a second overlay area corresponding to the unsecure network connection, wherein a second icon representing the second application is displayed within the second overlay area.

6. The method of claim 1 further comprising providing on a display window of the first application a visual indication that the first application is using the first secure network connection.

7. The method of claim 6 wherein the providing comprises tinting at least one of a background and tool bar of the first application display window.

8. The method of claim 1 further comprising providing in connection with the first icon a visual indication that the first application should be launched using the first secure network connection.

9. A computer program product for providing an overlay filter in a computer capable of at least one secure network connection for use by at least one user application of the computer, the computer program product comprising a computer-readable medium having stored thereon computer-executable instructions for:
establishing a first secure network connection;
launching a first application via the first secure network connection;
presenting on a display of the computer a visual representation, the visual representation illustrating that the first application is using the first secure network connection and comprising a first overlay area corresponding to the first secure network connection, wherein a first icon representing the first application is displayed within the first overlay area.

10. The computer program product of claim 9 wherein the computer-readable medium further has stored thereon computer-executable instructions for:
establishing a second secure network connection;
launching a second application via the second secure network connection;
wherein the visual representation further comprises a second overlay area corresponding to the second secure network connection, wherein a second icon representing the second application is displayed within the second overlay area.

11. The computer program product of claim 10 wherein the computer-readable medium further has stored thereon computer-executable instructions for:
layering the first and second secure network connections, wherein the second overlay area overlays the first overlay area in the visual representation.

12. The computer program product of claim 9 wherein the instructions for launching a first application further comprise instructions for dragging the first icon from a desktop of the computer display to the first overlay area.

13. The computer program product of claim 9 wherein the computer-readable medium further has stored thereon computer-executable instructions for:
establishing an unsecure network connection;
launching a second application via the unsecure network connection;
wherein the visual representation further comprises a second overlay area corresponding to the unsecure network connection, wherein a second icon representing the second application is displayed within the second overlay area.

14. The computer program product of claim 9 wherein the computer-readable medium further has stored thereon computer-executable instructions for providing on a display window of the first application a visual indication that the first application is using the first secure network connection.

15. The computer program product of claim 14 wherein the instructions for providing a visual indication further comprise instructions for tinting at least one of a background and tool bar of the first application display window.

16. The computer program product of claim 9 wherein the computer-readable medium further has stored thereon computer-executable instructions for providing in connection with the first icon a visual indication that the first application should be launched using the first secure network connection.

17. A system for providing an overlay filter in a computer capable of at least one secure network connection for use by at least one user application of the computer, the system comprising:
means for launching a first application via a first secure network connection;
means for presenting on a display of the computer a visual representation, the visual representation illustrating that a first application is using the first secure network connection and comprising a first overlay area corresponding to the first secure network connection, wherein a first icon representing the first application is displayed within the first overlay area.

18. The system of claim 17 further comprising:
means for launching a second application via a second network connection;
wherein the visual representation further comprises a second overlay area corresponding to the second secure network connection, wherein a second icon representing the second application is displayed within the second overlay area.

19. The system of claim 18 wherein the second network connection comprises a secure network connection, the system further comprising:
means for layering the first and second secure network connections, wherein the second overlay area overlays the first overlay area in the visual representation.

20. The system of claim 17 further comprising means for providing in connection with the first application a visual indication that the first application should be launched via the first secure network connection.
